(19) United States
(12) Patent Application Publication
(10) Pub. No.: US 2023/0393247 A1
(43) Pub. Date: Dec. 7, 2023

(54) MIRROR MODULE AND RANGING APPARATUS

(71) Applicant: DENSO CORPORATION, Kariya-city, Aichi-pref. (JP)

(72) Inventors: Koki HAYASHI, Kariya-city, Aichi-pref. (JP); Kunihiko HAYASHI, Kariya-city, Aichi-pref. (JP)

(21) Appl. No.: 18/451,545

(22) Filed: Aug. 17, 2023

Related U.S. Application Data
(63) Continuation of application No. PCT/JP2022/005705, filed on Feb. 14, 2022.

(30) Foreign Application Priority Data
Feb. 19, 2021 (JP) 2021-025392

(51) Int. Cl. G01S 7/481; G01S 17/931; G01S 7/51

(52) U.S. Cl. CPC G01S 7/4817; G01S 7/51; G01S 17/931

(57) ABSTRACT

A mirror module that deflects a non-visible laser light for scanning the non-visible laser light is provided with a deflection mirror; a mirror support; and an information display unit. The deflection mirror has a reflective surface that allows a visible light to be transmitted therethrough and reflects the non-visible laser light. The mirror support has a mirror mounting surface of which the shape corresponds to a shape of the reflective surface. The information display unit displays information related to the mirror module in a visible manner. The information display unit is disposed between the deflection mirror and the mirror mounting surface.

### CROSS REFERENCE TO RELATED APPLICATIONS

This application is the U.S. bypass application of International Application No. PCT/JP2022/005705 filed on Feb. 14, 2022, which designated the U.S. and claims priority to Japanese Patent Application No. 2021-025392 filed on Feb. 19, 2021, and the contents of both of these are incorporated herein by reference.

### BACKGROUND

### Technical Field

The present disclosure relates to a mirror module and a ranging apparatus.

### Description of the Related Art

A ranging apparatus is known in which laser light is emitted and reflected light is detected from an object that reflected the emitted laser light, thereby detecting a distance to the object. This type of ranging apparatus includes a deflection mirror rotationally driven to deflect laser light. The outputted laser light is reflected at the deflection mirror and emitted towards a direction depending on a rotation angle of the deflection mirror, thereby scanning a predetermined scanning area.

### SUMMARY

One aspect of the present disclosure is a mirror module that deflects a non-visible laser light for scanning the non-visible laser light, provided with a deflection mirror; a mirror support; and an information display unit. The deflection mirror has a reflective surface that allows visible light to be transmitted therethrough and reflects the non-visible laser light. The mirror support has a mirror mounting surface of which the shape corresponds to a shape of the reflective surface. The information display unit displays information related to the mirror module in a visible manner. The information display unit is disposed between the deflection mirror and the mirror mounting surface.

### BRIEF DESCRIPTION OF THE DRAWINGS

FIG. 1 is a perspective view showing an outline of a LiDAR apparatus;

FIG. 2 is an exploded view of the LiDAR apparatus;

FIG. 3 is a perspective view showing a configuration of a light detection module accommodated in a housing of the LiDAR apparatus;

FIG. 4 is an exploded view showing the mirror module, a partition plate and a clip in a scan unit;

FIG. 5 is a cross-sectional view showing the mirror module, the partition plate and the clip in the scan unit, which is sectioned along a surface perpendicular to a reflective surface of the deflection mirror and passing a rotational axis;

FIG. 6 is a diagram showing the mirror module when viewed from a reflection surface side of the deflection mirror;

FIG. 7 is a diagram showing the mirror module when viewed from a reflection surface side of the deflection mirror disposed at an opposite side of the mirror module shown in FIG. 6;

FIG. 8 is a diagram showing the mirror module when viewed from the side surface;

FIG. 9 is a schematic diagram showing an optical path when a return light enters a reflective surface of a light projection deflection part; and

FIG. 10 is a schematic diagram showing an optical path when a return light enters a reflective surface of a light projection deflection part.

### DESCRIPTION OF THE PREFERRED EMBODIMENTS

A ranging apparatus is known in which laser light is emitted and reflected light is detected from an object that reflected the emitted laser light, thereby detecting a distance to the object. This type of ranging apparatus includes a deflection mirror rotationally driven to deflect laser light. The outputted laser light is reflected at the deflection mirror and emitted towards a direction depending on a rotation angle of the deflection mirror, thereby scanning a predetermined scanning area.

Japanese patent laid-open publication No. 2020-112722 discloses a problem in which multiple reflection light (stray light or random light) possibly occurs in this type of ranging apparatus. The multiple reflection light may occur in the following manner. In the case where light waves outputted from an emission part is reflected at the deflection mirror and emitted outside the ranging apparatus after passing through the transmission member thereof, a part of the light waves are reflected at the transmission member and the reflected light waves are reflected again at the deflection mirror, whereby multireflection light is produced. The ranging apparatus disclosed by the above-mentioned patent literature is provided with a low reflection region having a low reflectance to light waves at an end portion of a transmission member side on a reflective surface of the deflection mirror, thereby suppressing occurrence of stray light.

Some of the ranging apparatus that perform a deflection scanning of laser light is provided with a mirror module including a deflection mirror and a mirror support where the deflection mirror is mounted. According to detailed research by the inventors, such a ranging apparatus has the following issues.

During a manufacturing process of the mirror module, information related to the mirror module such as an identification number or a test result may be required to be displayed on the mirror module such that the information is visually recognizable. In this case, an information display unit that displays the information is provided on an outer surface of the mirror module such that a label that displays the information is disposed on the outer surface of the mirror module. However, when the information display unit is disposed on the outer surface of the mirror module, the laser light to be scanned is reflected at the information display unit, whereby stray light is possibly produced. Also, when the information display unit is disposed at a portion other than the deflection mirror on the outer surface of the mirror module, a problem arises that the size of the mirror module becomes excessively large. Hence, it is required to prevent stray light from occurring while disposing the visually recognizable information display unit in the mirror module and without increasing the size of the mirror module.

Hereinafter, with reference to the drawings, exemplary embodiments of the present disclosure will be described.

### 1. Configuration

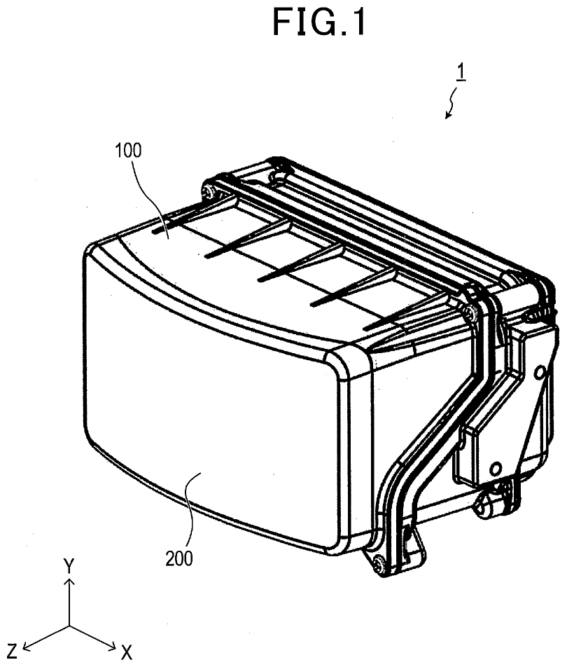

A LiDAR apparatus 1 shown in FIG. 1 serves as a ranging apparatus that emits laser light and receives a reflected light from an object, thereby measuring a distance to an object. The Lidar apparatus 1 is mounted on the vehicle and used for detecting various objects existing ahead of the vehicle. LiDAR is an abbreviation of Light Detection and Ranging. According to the present embodiment, the LiDAR apparatus 1 is configured to deflect and scan the laser light of non-visible light (i.e. light having wavelength less than 360 nm, or longer than 830 nm). The Lidar apparatus 1 scans the laser light to measure not only the distance but also the location. Hereinafter, when simply describing ‘laser light’, it refers to laser light scanned by the Lidar apparatus 1.

As shown in FIG. 1, the Lidar apparatus 1 is provided with a housing 100 and an optical window 200. The housing 100 is a resin-made box formed in a rectangular parallelopiped shape where one surface thereof is opened.

Hereinafter, a direction along a longitudinal direction of an opening having substantial rectangular shape of the housing 100 is referred to as a X-axis direction, a direction along a short side direction of the opening is referred to as a Y-axis direction and a direction perpendicular to a X-Y plane is referred to as a Z-axis direction. Note that left-right side in the X direction and up and down side in the Y direction are defined when viewed from the opening of the housing 100 in a state where the LiDAR apparatus 1 is mounted on the vehicle such that the X-Z plane is horizontal level. Also, front-back sides in the Z-axis are defined such that an opening side of the housing 100 is a front side, and depth side thereof is defined as a rear side.

The optical window 200 is provided at the opening of the housing 100 and is configured to be capable of allowing the laser light to be transmitted therethrough. According to the present embodiment, the optical window 200 suppresses transmission of the visible light (i.e. light having wavelength ranging from 360 nm to 830 nm). Specifically, the optical window 200 has a visible light cut filter. The visible light cut filter is configured as an optical filter that allows the non-visible light to be transmitted therethrough and suppresses transmission of the visible light. The visible light cut filter is provided to cover entire surfaces of an outer surface or an inner surface of the optical window. Alternatively, the optical window 200 itself may be formed of a member having the function of the above-described optical filter.

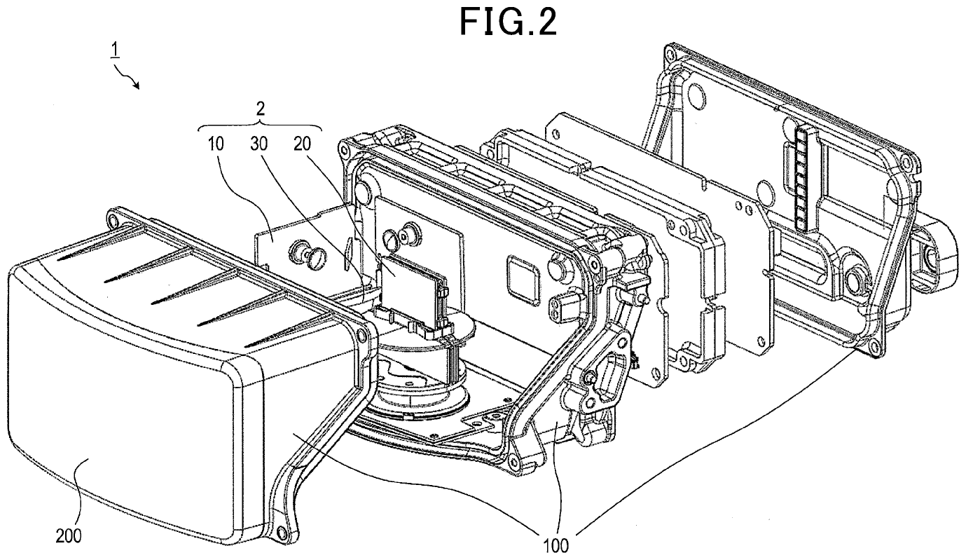

As shown in FIG. 2, an light detection module 2 is accommodated in an internal space of the housing 100. The light detection module 2 is provided with a light projection unit a scanning unit 20 and light reception unit 30.

Hereinafter, a configuration of the light detection module 2 will be described in detail.

### 2. Scan Unit

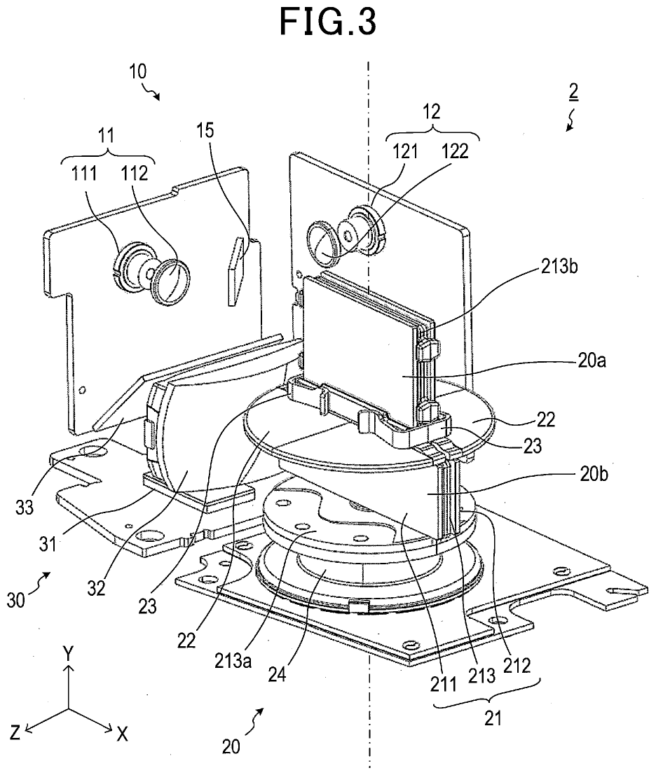

As shown in FIG. 3, the scan unit 20 is provided with a mirror module 21, a pair of partition plates 22, a pair of clips 23 and a motor 24. The pair of partition plates 22 is fixed to the mirror module 21 by the pair of clips 23. The mirror module 21 is provided standing on the motor 24.

The motor 24 is configured to rotatably drive the mirror module 21. According to the present embodiment, the motor 24 is configured as a brushless DC motor. The mirror module 21, the pair of partition plates 22 and the pair of clips 23, when being driven by the motor 24, rotatably move relative to the rotational axis as a center thereof indicated by a one dot chain line shown in FIG. 3.

### 3. Mirror Module

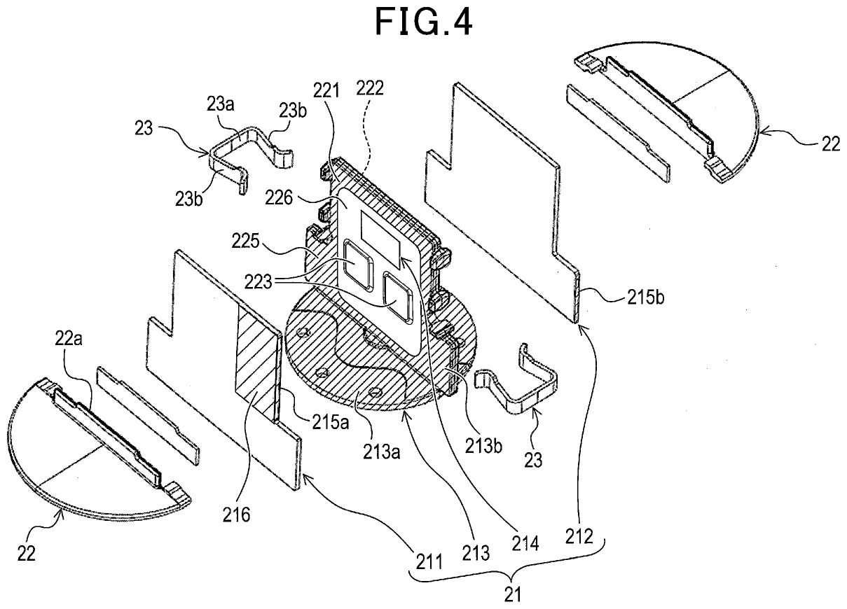

As shown in FIG. 4, the mirror module 21 is provided with a pair of deflection mirrors 211 and 212, a mirror support 213 and an information display unit 214.

The deflection mirrors 211 and 212 are each configured as a plate-shaped member having a reflective surface that reflects laser light. According to the present embodiment, the deflection mirrors 211 and 212 have reflective surfaces that allow the visible light to be transmitted therethrough and reflect the visible light. Specifically, the deflection mirrors 211 and 212 are each configured of a mirror substrate as a base formed by a member (e.g. glass) that allows at least visible light to be transmitted therethrough and a reflection film formed on the reflective surface by a depositing a material that allows the visible light to be transmitted therethrough and reflects laser light. More specifically, the deflection mirrors 211 and 212 are configured as a dielectric multilayered film mirror. The dielectric multilayered film mirror is configured of a glass substrate as a base and a dielectric multilayered film that allows the visible light to be transmitted therethrough and reflects non-visible light formed on a reflective surface by a deposition. Alternatively, the deflection mirrors 211 and 212 may be configured as a metallic half mirror. The metallic half mirror is configured such that a metal film in which the transmittance to visible light is higher than that of the non-visible light is formed on the reflective surface by a deposition.

The mirror support 213 has mirror mounting surfaces 221 and 222 of which the shapes correspond to the shapes of the reflective surfaces of the deflection mirrors 211 and 212. The deflection mirrors 211 and 212 are mounted to the mirror mounting surfaces 221 and 222, respectively such that a surface opposite to the reflective surface is supported by the mirror support 213. Specifically, as shown in FIGS. 3 and 4, the mirror support 213 is provided with a disk part 213a and a mounting part 213b. The disk part 213a is formed in a circular and plate shape of which the center of the circle is fixed to the rotational axis of the motor 24. The mounting part 213b is a part formed in a plate shape in which a pair of deflection mirrors 211 and 212 are mounted on both surfaces thereof. The mounting part 213b is provided standing on the disk-shaped surface. The shape of each mounting surface (i.e. mirror mounting surfaces 221 and 222) of the deflection mirrors 211 and 212 in the mounting part 213b corresponds to the shape of each reflective surface of the deflection mirrors 211 and 212.

The pair of deflection mirrors 211 and 212 have a shape in which 2 rectangles having mutually different widths in the longitudinal direction are integrated. Specifically, the shape of the rectangles is formed in the following manner.

A first rectangle and a second rectangle having a longitudinal width is larger than that of the first rectangle are arranged relative to a center axis where axes along the short sides of the first and second rectangles are aligned, thereby integrating the first and second rectangles to form the integrated shape. Hereinafter, in the pair of deflection mirrors 211 and 212, a portion corresponding to the first rectangle is referred to as a narrow width part and a portion corresponding to the second rectangle is referred to as a wide width part.

The pair of deflection mirrors 211 and 212 integrated via the mounting part 213b is provided to stand on the disk part 213a such that the position of the center axis corresponds to the center of the circle of the disk part 213a in a state of being integrated in which the wide width part is positioned in the down side. Thus, the mirror module 21 rotates around the rotational axis of the motor 24 as the center thereof.

The pair of partition plates 22 is configured such that a plate member having a circular shape of which the diameter is the same as the longitudinal width of the wide width part of the pair of deflection mirror 211 and 212 is divided into two semicircular portions. The pair of partition plates 22 are fixed to the mirror module 21 under a state where the narrow width part of the pair of deflection mirrors 211 and 212 are sandwiched by the pair of partition plates from both sides thereof and contacting with a step portion between the wide width part and the narrow width part of the pair of deflection mirrors 211 and 212.

Hereinafter, a portion in the pair of deflection mirrors 211 and 212, which is positioned at upper side of the pair of partition plates 22, that is, a portion in the narrow width side, is referred to as a light projection deflection part 20a, and a portion positioned at lower side of the pair of partition plates 22, that is, a portion in the wider width part, is referred to as a reception light deflection part 20b.

As shown in FIG. 4, each clip 23 is formed in a U-shape having a base 23a and a pair of holding parts 23b extending from the base 23a. As shown in FIG. 3 and FIGS. 6 to 7, for the pair of clips 23, the pair of holding parts 23b holds the pair of deflection mirrors 211 and 212 and the mirror support 213 at both ends of the narrow width parts of the pair of deflection mirrors 211 and 212 in a direction orthogonal to the rotational axis. The pair of deflection mirrors 211 and 212 and the mirror support 213 are urged by the pair of clips 23 and fixed in a state of being integrated. Note that the pair of partition plates 22 has a guide part 22a as a portion held by the holding parts 23b as shown in FIG. 4. When the clips 23 hold the pair of deflection mirrors 211 and 212 and the mirror support 213, the guide part 22a is also held, whereby the pair of partition plates 22 are fixed to the mirror module 21.

[3-1. Projection Part and Antireflection Layer]

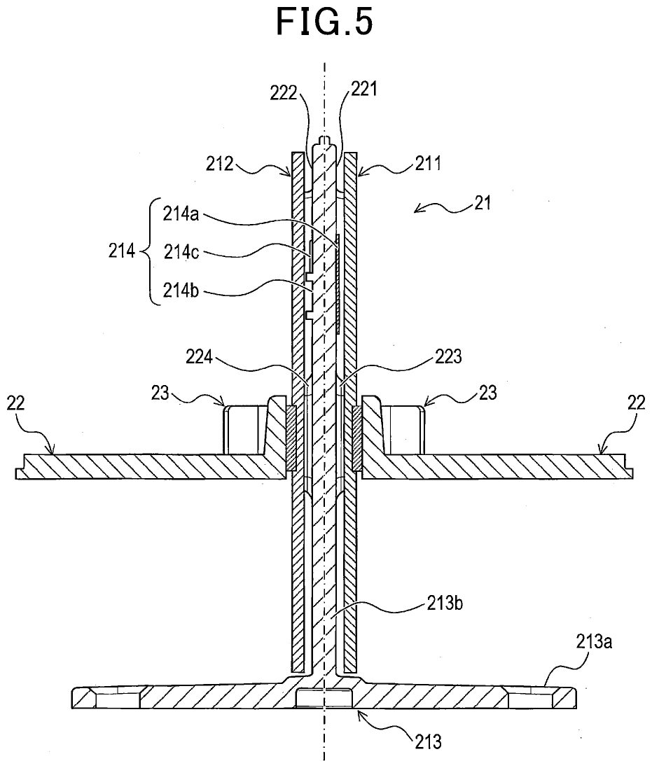

As shown in FIGS. 4 and 5, the mirror mounting surface 221 includes a projection part 223 as a projection for supporting the deflection mirror 211. The mirror mounting surface 221 contacts with a surface (hereinafter referred to as back surface) opposite to a reflective surface of the deflection mirror 211. Specifically, the projection part 223 serves a portion projecting towards a deflection mirror side from the mirror mounting surface 221, having an upper surface contacting with the back surface of the deflection mirror 211. According to the present embodiment, the projection part 223 serves as a portion projecting towards the deflection mirror 211 side from the mirror mounting surface 221 in a square truncated pyramid shape. Two projection parts 223 are provided on the mirror mounting surface 221.

The mirror mounting surface 222 is a surface opposite to the mirror mounting surface 221 of the mounting part 213b, having a projection part 224 that contacts with the back surface of the deflection mirror 212 and projects to support the deflection mirror 212. The mirror mounting surface 222 has the same shape as that of the mirror mounting surface 221. In other words, similar to the mirror mounting surface 221, the mirror mounting surface 222 has two projection parts 224.

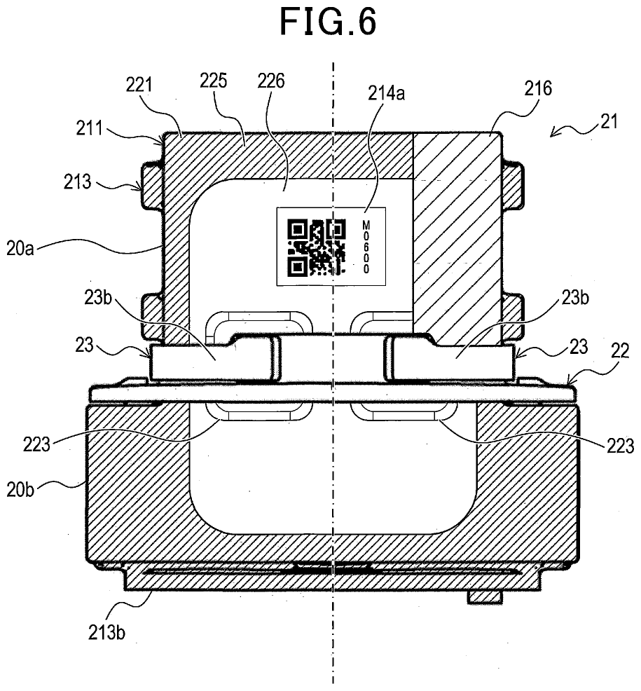

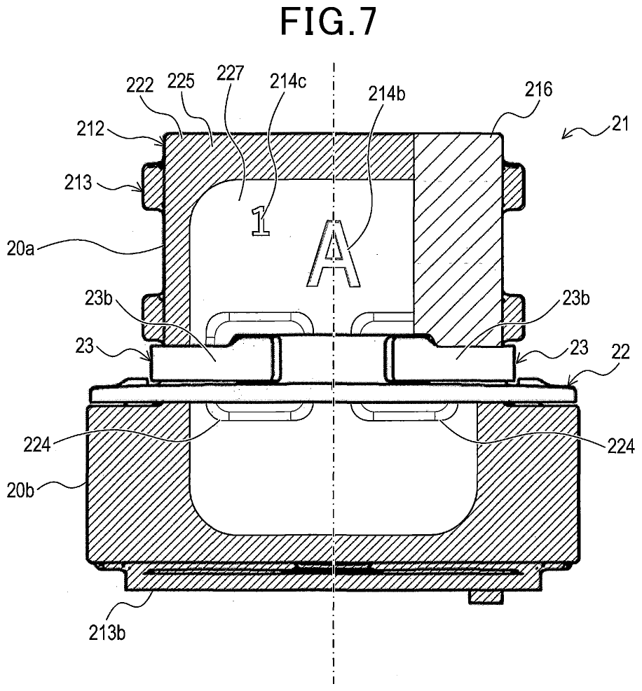

According to the present embodiment, as shown in FIGS. 5 to 7, the projection parts 223 and 224 are positioned at a center portion of the mirror mounting surface 221 and 222 with respect to the rotational axis direction. Specifically, the projection parts 223 and 224 are positioned at a portion urged by the clip 23. Note that FIGS. 6 and 7 are diagrams each showing the mirror module 21 when viewed from a reflective surface side of the deflection mirrors 211 and 212 and also showing a structure of the mirror mounting surfaces 221 and 222 when viewed from the deflection mirror 211 and 212 side.

In FIGS. 4, 6 and 7, as indicated by hatched lines, an antireflection layer 225 is formed on the surface of the mirror support 213. The antireflection layer 225 suppresses at least reflection of laser light. According to the present embodiment, the antireflection layer 225 suppresses reflection of non-visible light and visible light throughout the entire wavelength region. The antireflection layer 225 is a black coating film.

The mirror mounting surface 221 has a non-formation region 226 as a region where no antireflection layer 225 is formed. Further, the mirror mounting surface 222 has a non-formation region 227 as a region where no antireflection layer 225 is formed.

The projection part 223 is positioned at the non-formation region 226. The projection part 224 is positioned at the non-formation region 227. That is, the antireflection layer 225 is formed on the surface of the mirror support 213 without forming the antireflection layer 226 at least on the surfaces of the projections 223 and 224. According to the present embodiment, since a predetermined region including the projection parts 223 and 224 on the mirror mounting surfaces 221 and 222 are masked and black coating is performed, the predetermined region including the projection parts 223 and 224 on the mirror mounting surfaces 221 serve as the non-formation regions 226 and 227. However, the entire mirror mounting surfaces 221 and 222 may serve as the non-formation regions 226 and 227. Alternatively, only the surfaces of the projection parts 223 and 224 may be configured as the non-formation regions 226 and 227.

The anti-reflection layer 225 is formed to cover at least a side surface of the mirror support 213. In other words, the entire surface of the side surface of the mirror support 213 is covered by the antireflection layer 225. The side surface of the mirror support 213 refers to a portion except the mirror mounting surfaces 221 and 222 in the surface of the mirror support. Specifically, at least a portion not covered by the deflection mirrors 211 and 212 on the surface of the mirror support 213, that is, an exposed portion has the antireflection layer 225 formed thereon. Although, illustration is omitted, for the pair of partition plates 22 and the pair of clips 23, the entire surface is covered by the antireflection layer. Specifically, the antireflection layer is formed of a black coating film.

[3-2. Information Display Unit]

As shown in FIGS. 4 to 7, the mirror module 21 includes an information display unit 214 that displays information related to the mirror module 21 in a visible manner. The information related to the mirror module 21 includes, for example, identification information indicating identification number, date information indicating a shipping date, assembly date and the like, testing information indicating a result of the product, and manufacturing information indicating required information for manufacturing process such as a mold number.

The information display 214 is disposed between the deflection mirrors 211 and 212 and the mirror mounting surfaces 221 and 222. Note that variations for disposing the information display unit 214 between the deflection mirrors 211 and 212 and the mirror mounting surfaces 221 and 222 includes the following cases of (1) to (3).

(1) Case where the information display unit is configured as a part separately from the deflection mirror and the mirror support, and the part is disposed between the deflection mirror and the mirror mounting surface

As shown in FIGS. 5 and 6, the information display unit 214 may be configured as a part 214a disposed between the deflection mirror 211 and the mirror mounting surface 221, separately from the deflection mirror 211 and the mirror support 213. For example, the part 214a configured as a separate part separated from the deflection mirror 211 and the mirror support 213 serves as a label 214a disposed between the deflection mirror 211 and the mirror mounting surface 221. According to the present embodiment, the label 214a as the information display unit 214 is provided between the deflection mirror 211 and the mirror mounting surface 221, and the label 214a is attached to the mirror mounting surface 221. Note that the label 214a may be attached to the back surface of the deflection mirror 211.

(2) Case where the mirror mounting surface itself displays information and a portion displaying the information on the mirror mounting surface serves as information display unit

As shown in FIGS. 5 and 7, information related to the mirror module 21 may be displayed on the mirror mounting surface 222 itself. In this case, portions 214b and 214c of the mirror mounting surface 222 on which the information is displayed serves as the information display unit 214. Specifically, the information display unit 214 may be a part of the mirror support 213 and at least either the portion 214b of the mirror mounting surface 222 where the information is engraved or the portion 214c of the mirror mounting surface 222 where the information is printed.

That is, the portion 214b of the mirror mounting surface 222 where the information is engraved as a part of the mirror support 213 is a portion where engraving is added on the mirror mounting surface 222. Further, the portion 214c of the mirror mounting surface 222 where the information is printed as a part of the mirror support 213 is a portion where printing is added on the mirror mounting surface 222. According to the present embodiment, the portion 214b where engraving is added on the mirror mounting surface 222 and the portion 214c where printing is added on the mirror mounting surface 222 in addition to the above-described label 214a is provided as the information display unit 214.

(3) Case where information is displayed by the back surface of the deflection mirror itself and a portion where the information is displayed on the back surface of the deflection mirror serves as the information display unit

The back surface of the deflection mirror itself may display information related to the mirror module. In this case, a portion of the back surface of the deflection mirror where the information is displayed serves as the information display unit 214. Although illustration is omitted, the information display unit 214 may be a portion where the information is printed on the back surface of the deflection mirror as a part of the deflection mirror. In other words, the information display unit 214 may be a portion where printing is added on the back surface of the deflection mirror.

According to the present embodiment, the information display unit 214 (i.e. label 214a, the portion 214b where engraving is added on the mirror mounting surface 222 and the portion 214c where printing is added on the mirror mounting surface 222) is all arranged in the light projection deflection part 20a side. However, the information display unit 214 may be arranged in the reception light deflection part 20b or may be arranged in both the light projection deflection part 20a side and the reception light deflection part 20b side.

The portion 214b where engraving is added on the mirror mounting surface 222 and the portion 214c where printing is added on the mirror mounting surface 222 are positioned at the non-formation region 227 of the mirror mounting surface 222. The part 214a configured as a separate part separated from the deflection mirror 211 and the mirror support 213 is positioned at the non-formation region 226 according to the present embodiment. However, the part 214a may be disposed at any position as long as being positioned between the deflection mirror 211 and the mirror mounting surface 221. Also, the portion where printing is added on the back surface of the deflection mirror may be at any position on the back surface of the deflection mirror.

For the information display unit 214, reflectance to visible light has the following relationship.

Reflectance of reflective surface of the deflection mirrors 211 and 212<Reflectance of the information display unit 214

For the reflectance of the above-described information display unit 214, the reflectance of the portion 214c where printing is added on the mirror mounting surface 222 in the information display unit 214 is either a reflectance of a portion indicating information such as characters or a reflectance of a surrounding portion thereof. For example, this includes a case where black characters are printed on a white substrate or white characters are printed on a black substrate, that is, the reflectance of either the portion indicating the information such as characters or the surrounding portion is larger than the reflectance of the reflective surface of the deflection mirrors 211 and 212.

[3-3. Laser Printing on Mirror Mounting Surface]

In the case where the information display unit 214 is the portion 214c where printing is added on the mirror mounting surface 222, printing on the mirror mounting surface 222 may be performed by laser machining. That is, the information display unit 214 may be a portion 214c where the information is laser-printed on the mirror mounting surface 222 as a part of the mirror support 213.

The laser printing can be performed in a state where the deflection mirror 212 is disposed on the mirror support 213, that is, the mirror module 21 is assembled. Specifically, in a state where the deflection mirror 212 is disposed on the mirror support, laser beam of the visible light is emitted to the mirror mounting surface 222 through the deflection mirror 212, thereby printing on the mirror mounting surface. Since the deflection mirror 212 allows the visible light to be transmitted therethrough, the visible light laser is utilized, thereby printing on the mirror mounting surface 222 through the deflection mirror 212.

According to the present embodiment, printing of the portion 214c on the mirror mounting surface 2 is performed by laser-printing with the above-described method.

### 4. Light Projection Unit

As shown in FIG. 3, the light projection unit 10 is provided with a pair of light emission modules 11 and 12. The light projection unit 10 may be provided with a light projection folded mirror 15.

The light emission module 11 is provided with a light source 111 and a light emission lens 112 and both of these are arranged to face each other. For the light source 111, a semiconductor laser is used. According to the present embodiment, the light source 111 is configured to produce laser light of a non-visible light (i.e. non-visible laser light). Specifically, the light source 111 is configured as an infrared light semiconductor laser that produces laser light of infrared light. The light emission lens 112 narrows a beam width of the laser light emitted from the light source 111. Similarly, the light emission module 12 includes a light source 121 and the light emission lens 122. Since the light emission module 12 is the same as the light emission module 11, explanation thereof will be omitted.

The light projection folded mirror 15 changes the travel direction of the laser light.

The light emission module 11 is disposed such that the laser light outputted from the light emission module 11 is directly incident on the light projection deflection part 20a.

The light emission module 12 is disposed such that the travel direction of the laser light outputted from the light emission module 12 is changed by approximately 90° by the light projection folded mirror 15, thereby causing the laser light to be incident on the light projection deflection part 20a.

Here, the light emission module 11 is disposed such that laser light is emitted from a left side to a right side in the X axis direction. The light emission module 12 is disposed such that the laser light is emitted from a rear side to a front side in the Z axis direction. Further, the light projection folded mirror 15 is disposed not to disturb the laser light path from the light emission module 11 towards the light projection deflection part 20a.

### 5. Light Reception Unit 30

The light reception unit 30 is provided with a light rection element 31. The light reception unit 30 may be provided with a light reception lens 32 and a light reception folded mirror 33.

The light reception element 31 is configured to receive reflection light from an object that reflected the laser light outputted from the light projection unit. Specifically, the light reception element 31 includes an APD array in which a plurality of APDs are arranged in a row. APD refers to Avalanche Photo Diode.

The light reception lens 32 narrows the light coming from the reception light deflection part 20b.

The light reception folded mirror 33 is disposed in the left side of the light reception lens 32 in the X axis direction and changes the travel direction of the light. The light reception element 31 is disposed in the lower side of the light reception folded mirror 33.

The light reception folded mirror 33 is disposed so as to change the light path to be deflected downward by 90° such that the light being incident via the light reception lens 32 from the reception light deflection part 20b reaches the light reception element 31.

The light reception lens 32 is disposed between the reception light deflection part and the light reception folded mirror 33. The light reception lens 32 narrows a beam diameter of the light beam incident on the light reception element 31 to be like an element width of the APD.

### 6. Operation of Light Detection Module

The laser light outputted from the light emission module 11 in incident on the light projection deflection part 20a. Also, the travel direction of the laser light outputted from the light emission module 12 is changed by approximately 90° by the light projection folded mirror 15, thereby causing the laser light to be incident on the light projection deflection part 20a. The laser light incident on the light projection deflection part 20a is emitted via the optical window 200 towards a direction depending on the rotation speed of the mirror module 21. An area to which the laser light is emitted via the mirror module refers to a scanning area. For example, an area extending in the X axis direction by ±60° in which a front direction along the Z axis direction is defined as 0° can be defined as a scanning area.

A reflection light from an object to be detected, which is positioned in a predetermined direction depending on the rotational position of the mirror module 21, that is an emission direction of the laser light emitted from the light projection deflection part 20a, is transmitted through the optical window 200 and reflected at the reception light deflection part 20b. The reflection light reflected at the reception light deflection part is received by the light reception element 31 via the light reception lens 32 and the light reception folded mirror 33.

### 7. Shielding Part and Low Reflection Part

[7-1. Shielding Part]

As described above, the deflection mirrors 211 and 212 are each configured as a mirror having a glass substrate as a base and forming a reflection film on the reflective surface thereof by depositing a substance that reflects the laser light. The reflective surfaces of the deflection mirrors 211 and 212 have reflection films, but the side surfaces do not have reflection films. Hence, laser light is transmitted through the side surfaces.

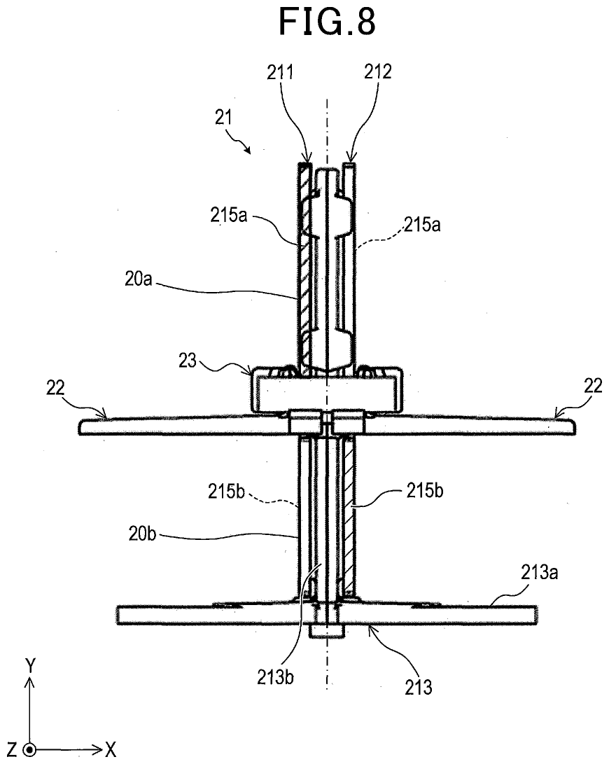

As indicated by a hatching part shown in FIG. 8, a part of side surfaces deflection mirrors 211 and 212 has a shielding parts 215a and 125b at which the transmittance to at least laser light is reduced. The shielding parts 215a and 215b are configured by printing a block ink on the surface of the mirror substrate, for example. Note that the antireflection layer 225 is not shown in FIGS. 8 to 10.

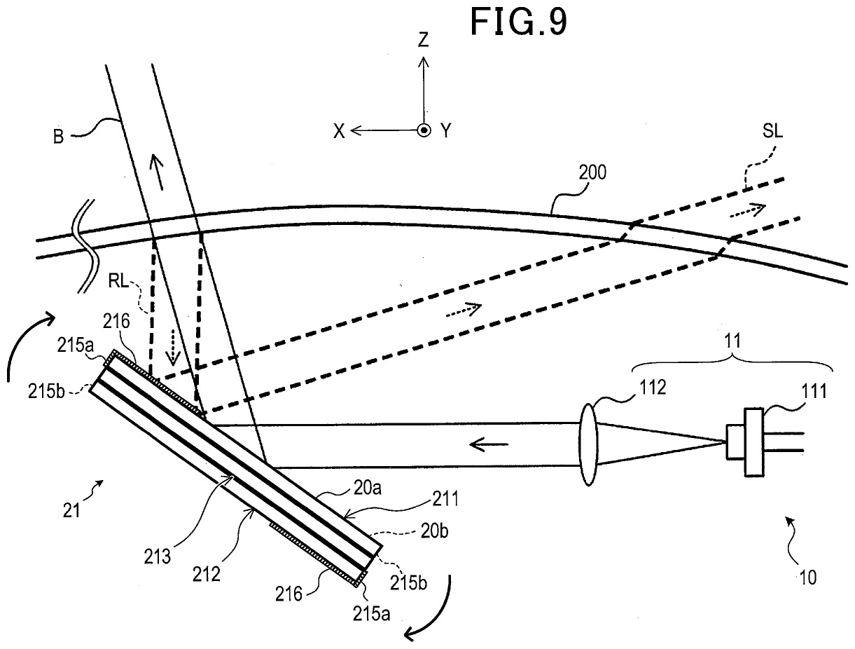

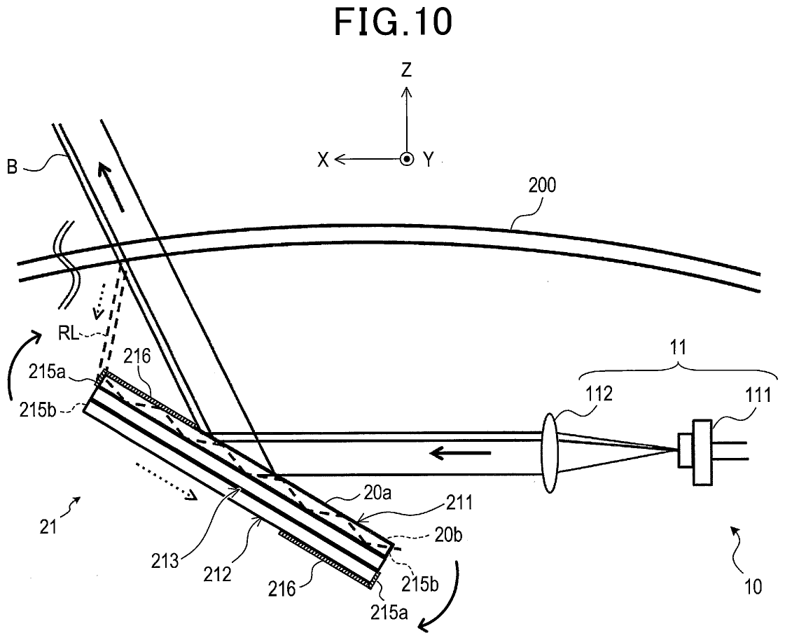

With reference to FIGS. 9 and 10, the positions where the shielding parts 215a and 215b are formed will be described. FIGS. 9 and 10 are schematic diagrams showing a space accommodating the light detection module 2 inside the housing 100 when viewed from an upper side in the Y-axis direction. FIGS. 9 and 10 illustrate the light projection unit 10 and the light projection deflection part 20a positioned in an upper side space in the Y-axis direction in the above-space, and illustration of the light reception unit 30 and the reception light deflection part 20b is omitted. In FIGS. 9 and 10, the reflective surface of the deflection mirror 211 and the light reception unit 30 are oriented towards a direction where the light projection unit 10 and the light projection deflection part 20a are positioned.

The shielding part 215a is formed, for each of the deflection mirrors 211 and 212, on a side surface close to the optical window 200 among both side surfaces relative to the rotational axis of the light projection deflection part 20a in a state where the reflective surface faces the light projection unit 10. In FIGS. 9 and 10, the shielding part 215a in the respective deflection mirrors 211 and 212 is indicated by a hatching part of the side surface of the light projection deflection part 20a.

The shielding part 215b is formed, for each of the deflection mirrors 211 and 212, on a side surface away from the optical window 200 among both side surfaces relative to the rotational axis of the reception light deflection part 20b in a state where the reflective surface faces the light reception unit 30. Although illustration is omitted in FIGS. 9 and 10, each shielding part 215b in each of the deflection mirrors 211 and 212 is positioned at a side surface of the reception light deflection part 20b which is in an opposite side of the side surface on which the shielding part 215a is provided.

[7-2. Low Reflection Part]

As indicated by a wide hatching line in FIGS. 6 and 7, a low reflection part 216 is formed at a part of the reflective surfaces 211 and 212. The low reflection part 216 is unlikely to reflect at least laser light. The low reflection part 216 is configured by printing black ink same as that of the shielding parts 215a and 215b on the reflection film.

With reference to FIGS. 9 and 10, position at which the low reflection part 216 is formed will be described. The low reflection part 216 is formed, for each of the deflection mirrors 211 and 212, at an end portion of the reflective surface of the light projection deflection part 20a which is in the optical window 200 side in a state where the reflective surface faces the light projection unit 10. In FIGS. 9 and 10, the low reflection part 216 in each of the deflection mirrors 211 and 212 is indicated by hatching on the reflective surface of the light projection deflection part 20a. That is, the low reflection part 216 is positioned at the end portion of the reflective surface of the light projection deflection part 20a in the same side as the side surface where the shielding part 215a is provided. In the case where the shielding parts 215a and 125b and the low reflection part 216 are formed using the same black ink, the shielding part 215a and the low reflection part 216 may be continuously formed.

[7-3. Positions of Shielding Part and Low Reflection Part with Respect to a Light Path of Return Light]

Similar to the LIDAR apparatus 1 of the present embodiment, according to a configuration in which the optical window 200 is provided and the laser light is scanned using a rotationally driven deflection mirrors 211 and 212, as shown in FIGS. 9 and 10, when the laser light reflected at the light projection deflection part 20a passes through the optical window 200, a part of the laser light is further reflected at the optical window 200 and becomes a return light RL. Hence, the return light RL may be returned to the light projection deflection part 20a without being emitted outside the housing 100. The actual light path B of the laser light reflected at the light projection deflection part 20a of the deflection mirror 211 and emitted outside is indicated by a solid line, and the light path of the return light RL is indicated by the dotted line. In FIG. 10, among produced return light RL, only a return light RL incident on the side surface of the light projection deflection part 20a of the deflection mirror 211 in the optical window 200 side is indicated by the dotted line, and the laser light reflected at the optical window 200 and becomes the return light RL is indicated by a double line.

FIG. 9 shows a case where the return light RL is incident on the reflective surface of the light projection deflection part 20a of the reflection mirror 211. Assuming that the low reflection part 216 is not present, the return light RL is reflected again at the reflective surface of the light projection deflection part 20a and, as indicated by the dotted line, a stray light SL is produced as a light emitted in a direction different from the correct direction along which the laser light should emitted. The stray light SL, once reflected at an object, returns the same path as the emitted path in a reverse direction and is received by the light reception unit 30. This causes a ghost which is an object detected even it does not exist. The laser light emitted from the light projection unit 10 is reflected at a portion around the center of the reflective surface of the light projection deflection part 20a. However, the return light RL is reflected at a portion closer to the optical window 200 side than the portion at which the emitted laser light is reflected.

According to the present embodiment, since the low reflection part 216 is formed in a region where the return light RL is reflected on the reflective surface of the light projection deflection part 20a, reflection of the return light RL is suppressed and a quantity of light of the stray light SL is reduced. Thus, occurrence of ghosts due to the return light RL can be reduced. Since the low reflection part 216 is formed closer to the optical window 200 side than the center portion of the reflective surface of the light projection deflection part 20a which is a region where the laser light emitted from the light projection unit 10 is reflected, it is less likely to influence the reflection of the laser light.

FIG. 10 illustrates a case where the return light RL is incident on a side surface in the optical window side of the light projection deflection part 20a of the deflection mirror 211. Assuming that the shielding part 215a is not present, the return light RL reaches a portion inside the deflection mirror 211 from the side surface. Then, as indicated by the dotted line, the return light RL passes through portion inside the deflection mirror 211 being repeatedly reflected thereinside from the light projection deflection part 20a to the reception light deflection part 20b. The return light RL that passes through a portion inside the deflection mirror 211 and reaches the side surface in the light reception unit 30 side of the reception light deflection part 20b, if no shielding part 215b is present, travels outside the deflection mirror 211 from the side surface, and is received by the light reception unit 30. Thus, ghosts are produced.

According to the present embodiment, the shielding part 215a is formed on the side surface of the light projection deflection part 20a which serves as an input portion of the return light RL when entering a portion inside the deflection mirrors 211 and 212. Further, the shielding part 215b is formed on the side surface of the reception light deflection part 20b which serves as an output portion of the return light RL when passing through the inside portion of the deflection mirrors 211 and 212. Thus, the light quantity of the return light RL received by the light reception unit 30 after passing through the inside portion of the deflection mirrors 211 and 212 is reduced, whereby occurrence of ghosts due to the return light RL can be suppressed.

### 8. Effects and Advantages

According to the above-described embodiment, the following effects and advantages can be obtained.

(8a) The mirror module 21 that deflects the non-visible laser light for scanning the laser light is provided with the deflection mirrors 211 and 212, the mirror support 213 having the mirror mounting surfaces 221 and 222 and the information display unit 214. The deflection mirrors 211 and 212 allow visible light to be transmitted therethrough and have a reflective surface that reflects the laser light. The information display unit 214 displays information related to the mirror module 21 in a visible manner. The information display unit 214 is disposed between the deflection mirrors 211, 212 and the mirror mounting surfaces 221, 222. According to such a configuration, the information display unit 214 can be disposed inside the mirror module to be visually recognized. Since the deflection mirrors 211 and 212 allow visible light to be transmitted therethrough, the information display unit can be recognized from a portion of the deflection mirrors 211 and 212. However, the non-visible laser light is reflected at the reflective surface of the deflection mirrors 211 and 212. That is, the information display unit 214 is disposed at a portion that does not reflect the laser light. Hence, compared to a case where the information display unit 214 is disposed on an outer surface of the mirror module 21, a stray light caused by the laser light being reflected at the information display unit 214 can be prevented from occurring. Therefore, stray light is prevented from occurring while disposing the information display unit which can be visually recognized on the mirror module 21.

(8b) For a portion 214c where the information is printed on the mirror mounting surface 222 in the information display unit 214, printing on the mirror mounting surface 222 is performed by a laser printing method. According to this configuration, since a laser printing can be performed on the mirror mounting surface 222 in a state where the mirror module is assembled, the printing process can be performed at the final step of the manufacturing of the mirror module 21. Thus, for example, the laser printing can be performed only for a product that satisfies a criteria of the test process performed after the assembling process of the mirror module 21. In other words, for example, in the case where the information display unit 214 sequentially displays the identification numbers, when the information display unit 214 such as a label is arranged before the assembly process and if a product not satisfying the criteria at the test process after the assembling process is eliminated, a missing number occurs in the identification numbers. According to the present embodiment, when performing the laser printing in the final step of the manufacturing of the mirror module 21, no missing number occurs in the identification number.

(8c) The mirror mounting surfaces 221 and 222 have the projection parts 223 and 224 that contact with the back surface of the deflection mirrors 211 and 212 and supports the deflection mirrors 211 and 212. The mirror support 213 has the antireflection layer 225 formed on the surface thereof. The mirror mounting surfaces 221 and 222 have the non-formation regions 226 and 227 which are regions where no antireflection layer 225 is formed and the projection parts 223 and 224 are positioned in the non-formation regions 226 and 228. With this configuration, stray light can be prevented from occurring while avoiding the deterioration of an accuracy of mounting the deflection mirrors 211 and 212 on the mirror support 213. In more detail, according to the confirmation of the present embodiment, the following problems can be solved.

In a ranging apparatus in which laser light is scanned using a mirror module provided with a deflection mirror and a mirror support, it is possible that the laser light is reflected at the mirror support, thereby causing stray light. In order to prevent stray light from occurring, the surface of the mirror support may be covered by an antireflection layer that reduces a reflection of the laser light. However, in the case where the antireflection layer is formed on a surface contacting with the deflection mirror, a problem arises that the mounting accuracy of the deflection mirror on the mirror support is deteriorated. Hence, stray light is required to be prevented from occurring while avoiding the deterioration of an accuracy of mounting the deflection mirrors 211 and 212 on the mirror support 213.

According to the configuration of the present embodiment, the antireflection layer 215 can be provided on the mirror support 213 without deteriorating the accuracy of mounting the deflection mirrors on the mirror support 213. Hence, compared to a case where no antireflection layer 225 is provided on the mirror support 213, stray light can be prevented from occurring while avoiding deterioration of the accuracy of mounting the deflection mirrors 211 and 212 on the mirror support 213.

(8d) In the information display unit 214, the portion 214b where engraving is added on the mirror mounting surface 222 and the portion 214c where printing is added on the mirror mounting surface 222 are positioned at the non-formation region 227 of the mirror mounting surface 222. According to this configuration, since the portion 214b where engraving is added on the mirror mounting surface 222 and the portion 214c where printing is added on the mirror mounting surface 222 are not overlapped with the antireflection layer 225, the information display unit 214 can readily be recognized.

(8e) The antireflection layer 225 is formed to cover at least the side surface of the mirror support 213. With this configuration, a stray light caused by the laser light reflected at the side surface of the mirror support can be prevented from occurring.

(8f) The deflection mirrors 211 and 212 are configured of a dielectric multilayered film mirror or a metallic half mirror. With this configuration, the deflection mirrors 211 and 212 having a reflective surface that allows visible light to be transmitted therethrough and reflects laser light can readily be achieved.

(8g) The Lidar apparatus 1 mounted on the vehicle to be used includes the mirror module 21 having a function of preventing the above-described stray light from occurring. With this configuration, a ranging accuracy can be improved for an on-vehicle ranging apparatus in which high ranging accuracy is required.

(8h) In the Lidar apparatus 1 that deflects non-visible laser light, the optical window 200 that allows at least laser light to be transmitted therethrough is provided at an opening of the housing 100 that accommodates the mirror module 21. The optical window 200 suppresses transmission of the visible light. With this configuration, visible light can be prevented from being transmitted through the optical window 200 and from entering inside the housing 100, thereby suppressing influence of the visible light when ranging is performed. Hence, the ranging accuracy can be improved.

### 9. Other Embodiments

Embodiments of the present disclosure are described so far. The present disclosure is not limited to the above-described embodiments but may be modified in various manners.

(9a) According to the above-described embodiments, as the information display unit 214, a part separately from the deflection mirror 211 and the mirror support 213 (i.e. label 214a) and a part of the mirror support 213 (i.e. the portion 214b where engraving is added on the mirror mounting surface 222 and the portion 214c where printing is added on the mirror mounting surface 222) are exemplified. However, the information display unit is not limited to these configurations. The information display unit may be a part of the deflection mirror (i.e. a printed portion on the back surface of the deflection mirror). Further, as the information display unit, any one of a single unit among a part separately from the deflection mirror and the mirror support, a part of the mirror support and a part of the deflection mirror may be provided or a combination of these units may be provided.

(9b) According to the above-described embodiments, two projection parts 223 and 224 are provided for the mirror mounting surfaces 221 and 222 respectively. However, the number of projection parts is not limited to this number. For example, three or more projection parts may be provided on the mirror mounting surface or one projection part may be provided on the mirror mounting surface. For a shape of the projection part, as long as a projection part contacts with the back surface of the deflection mirror and projects to support the deflection mirror, any shape may be utilized without being limited to the shape described in the present embodiment.

(9c) According to the above-described embodiments, the mirror mounting surfaces 221 and 222 have the projection parts 223 and 224, and the antireflection layer 225 is formed on the surface of the mirror support 213. However, the mirror support is not limited to this configuration. For example, the mirror support may not be provided with the projection part and the antireflection layer on the surface.

(9d) According to the above-described embodiments, it is exemplified that the deflection mirrors 211 and 212 are configured of a dielectric multilayered film mirror or a metallic half mirror.

However, configurations other than the dielectric multilayered film mirror or the metallic half mirror may be utilized.

(9e) According to the above-described embodiments, the Lidar apparatus 1 is utilized as an on-vehicle use. However, the Lidar apparatus 1 may be utilized as an apparatus other than for on-vehicle use.

(9f) According to the above-described embodiments, a configuration is exemplified in which a brushless DC motor is used as the motor 24. However, a motor other than the brushless motor may be utilized.

(9g) According to the above-described embodiments, the optical window 200 has a function of suppressing a transmission of visible light. However, the optical window 200 may not have such a function.

(9h) According to the above-described embodiments, the Lidar apparatus 1 is configured to deflect and scan the non-visible laser light. However, the Lidar apparatus may be configured to deflect and scan a visible laser light.

(9i) According to the above-described embodiments, the deflection mirrors 211 and 212 have reflective surfaces that allow visible light to be transmitted therethrough and reflect non-visible laser light. However, configuration of the deflection mirror is not limited to this configuration. For example, the deflection mirror may be configured not to allow visible light to be transmitted therethrough as long as the deflection mirror has a reflective surface that reflects laser light.

(9j) According to the above-described embodiments, the information display unit 214 is disposed between the deflection mirrors 211, 212 and the mirror mounting surfaces 221, 222. However, the mirror module may not be provided with the information display unit.

(9k) Multiple functions of a single component in the above-described embodiment may be distributed or functions included in a plurality of components may be integrated to a single component. Further, some of the configurations of the above-described embodiment may be omitted. In addition, at least some of the configurations of the above-described embodiment may be added to or replaced with the configurations of the other embodiments described above.

### CONCLUSION

The present disclosure provides a technique for suppressing occurrence of stray light.

One aspect of the present disclosure is a mirror module that deflects a non-visible laser light for scanning the non-visible laser light, provided with a deflection mirror; a mirror support; and an information display unit. The deflection mirror has a reflective surface that allows visible light to be transmitted therethrough and reflects the non-visible laser light. The mirror support has a mirror mounting surface of which the shape corresponds to a shape of the reflective surface. The information display unit displays information related to the mirror module in a visible manner. The information display unit is disposed between the deflection mirror and the mirror mounting surface.

According to this configuration, the information display unit can be disposed inside the mirror module to be visually recognized without increasing the size of the mirror module. Thus, the stray light is prevented from occurring while providing the information display unit which can be visually recognized.

Another aspect of the present disclosure is a mirror module that deflects a laser light for scanning the laser light, provided with a deflection mirror and a mirror support. The deflection mirror has a reflective surface that reflects the laser light. The mirror support has a mirror mounting surface of which the shape corresponds to a shape of the reflective surface. The mirror mounting surface includes a projection part that contacts a surface of the deflection mirror which is an opposite surface of the reflective surface of the deflection mirror and supports the deflection mirror. The mirror supports includes an antireflection layer on a surface thereof. The antireflection layer suppresses at least reflection of the laser light. The mirror mounting surface includes a non-formation region where the antireflection layer is not formed. The projection part is positioned in the non-formation region.

In order to prevent stray light which is caused by laser light being reflected by the mirror support from occurring, the surface of the mirror support may be covered by an antireflection layer. However, in the case where the antireflection layer is formed on a surface contacting the deflection mirror, a problem arises that the mounting accuracy of the deflection mirror on the mirror support is deteriorated. In contrast, according to the present disclosure, since the antireflection layer can be provided on the mirror support without deteriorating the mounting accuracy of the deflection mirror on the mirror support, stray light is prevented from occurring while avoiding a deterioration of the mounting accuracy of the deflection mirror on the mirror support.

What is claimed is:

1. A mirror module that deflects a non-visible laser light for scanning the non-visible laser light, comprising:
a deflection mirror having a reflective surface that allows a visible light to be transmitted therethrough and reflects the non-visible laser light;
a mirror support having a mirror mounting surface of which the shape corresponds to a shape of the reflective surface; and
an information display unit that displays information related to the mirror module in a visible manner,
wherein
the information display unit is disposed between the deflection mirror and the mirror mounting surface.

2. The mirror module according to claim 1, wherein
the information display unit is configured as a part of the mirror support and a portion where the information is laser-printed on the mirror mounting surface.

3. The mirror module according to claim 1, wherein
the mirror mounting surface includes a projection part that contacts a surface of the deflection mirror which is an opposite surface of the reflective surface of the deflection mirror and supports the deflection mirror;
the mirror supports includes an antireflection layer on a surface thereof;
the antireflection layer suppresses at least a reflection of the laser light; and
the mirror mounting surface includes a non-formation region where the antireflection layer is not formed; and
the projection part is positioned in the non-formation region.

4. The mirror module according to claim 3, wherein
the antireflection layer suppresses reflection of at least the laser light and the visible light;
the information display unit is configured, as a part of the mirror support, to be at least one of a portion where the information is engraved on the mirror mounting surface and a portion where the information is printed on the mirror mounting surface; and
the information display unit is positioned in the non-formation region on the mirror mounting surface.

5. The mirror module according to claim 4, wherein
for the information display unit, a reflectance of the visible light satisfies a relationship:
reflectance of the reflective surface of the deflection mirror<reflectance of the information display unit.

6. A mirror module that deflects a laser light for scanning the n laser light, comprising:
a deflection mirror having a reflective surface that reflects the laser light; and
a mirror support having a mirror mounting surface of which the shape corresponds to a shape of the reflective surface,
wherein
the mirror mounting surface includes a projection part that contacts a surface of the deflection mirror which is an opposite surface of the reflective surface of the deflection mirror and supports the deflection mirror;
the mirror supports includes an antireflection layer on a surface thereof;
the antireflection layer suppresses at least a reflection of the laser light; and
the mirror mounting surface includes a non-formation region where the antireflection layer is not formed; and
the projection part is positioned in the non-formation region.

7. The mirror module according to claim 3, wherein
the antireflection layer is formed to cover at least a side surface of the mirror support.

8. The mirror module according to claim 1, wherein
the deflection mirror is configured of a dielectric multilayered film mirror or a metallic half mirror.

9. The mirror module according to claim 1, wherein
the mirror module is used for a ranging apparatus mounted on a vehicle.

10. A ranging apparatus comprising:
a mirror module that deflects a non-visible laser light for scanning the non-visible laser light, comprising:
a deflection mirror having a reflective surface that allows a visible light to be transmitted therethrough and reflects the non-visible laser light;
a mirror support having a mirror mounting surface of which the shape corresponds to a shape of the reflective surface; and
an information display unit that displays information related to the mirror module in a visible manner, wherein the information display unit is disposed between the deflection mirror and the mirror mounting surface; and
a motor configured to rotationally drive the mirror module.

11. The ranging apparatus according to claim 10, wherein
the motor is configured as a brushless DC motor.

12. A ranging apparatus deflecting a non-visible laser light for scanning the non-visible laser light, the ranging apparatus comprising:
a mirror module comprising a deflection mirror having a reflective surface that allows a visible light to be transmitted therethrough and reflects the non-visible laser light; a mirror support having a mirror mounting surface of which the shape corresponds to a shape of the reflective surface; and an information display unit that displays information related to the mirror module in a visible manner, wherein the information display unit is disposed between the deflection mirror and the mirror mounting surface;
a housing having an opening and accommodating the mirror module in an internal space thereof; and
an optical window provided at the opening of the housing, allowing at least the non-visible laser light to be transmitted therethrough,
wherein
the optical window suppresses transmission of a visible light.
